(19) United States
(12) Patent Application Publication
(10) Pub. No.: US 2010/0321561 A1
(43) Pub. Date: Dec. 23, 2010

(54) SYSTEM, COMPONENTS, AND METHODS FOR VIEWING DOCUMENTS AND OBJECTS USING A WEBCAM

(76) Inventors: Keith Brent DUNCAN, Norcross, GA (US); Robert Van VARVICK, Yardley, PA (US)

Correspondence Address: GARDNER GROFF GREENWALD & VILLANUEVA. PC, 2018 POWERS FERRY ROAD, SUITE 800, ATLANTA, GA, 30339, US

(21) Appl. No.: 12/869,249

(22) Filed: Aug. 26, 2010

Related U.S. Application Data
(63) Continuation-in-part of application No. 12/623,173, filed on Nov. 20, 2009.
(60) Provisional application No. 61/208,656, filed on Feb. 26, 2009.

(51) Int. Cl. H04N 5/225

(52) U.S. Cl. 348/373; 348/E05.024

(57) ABSTRACT

An image sensor support device comprising a foot assembly releasably coupled with respect to a base and an image sensor mount rotatably coupled with respect to the foot assembly. The image sensor mount is rotatably secured to an elongated stem assembly and the stem assembly is rotatably secured to the foot assembly.

### CROSS REFERENCE TO RELATED APPLICATIONS

This application is a continuation-in-part of, and claims the priority benefit of, U.S. Non-Provisional patent application Ser. No. 12/623,173 filed Nov. 20, 2009, which claims the priority benefit of U.S. Provisional Patent Application Ser. No. 61/208,656 filed Feb. 26, 2009, all of which are hereby incorporated herein by reference for all purposes.

### TECHNOLOGY FIELD

The technology described herein relates generally to multi-media communication devices. More specifically, this technology relates to a system, components, and methods for viewing documents or objects using a camera.

### BACKGROUND OF THE INVENTION

Due to increases in travel costs and the desire for more efficient business processes, there is a need for improved products and methods to conduct meetings between persons located in different locations.

Existing peer-to-peer (P2P) technology allows a remotely located person to review a remotely located computer screen and to allow the people who are participating in the meeting to view each other from a webcam into which the viewers generally speak. However, very often, the people participating in the meeting are discussing details regarding a document or an object. The inability for a remotely located meeting participant to observe that document or object disrupts the feeling of that participant that they are present in the meeting. As a result, the participants can feel disconnected, which decreases the perceived quality and/or effectiveness of remote meetings.

This feeling of “presence” is a central feature affecting the perceived meeting experience of the participants. A “good meeting” may be one where the participants feel that they had a personal connection, and, for many business and personal settings this feeling of connection is deemed critical. The lack of the feeling of presence with existing peer-to-peer technology generally does not supplant the desire to meet in person to conduct business with another person.

Current research indicates that people will be much more willing to forego travel if technology existed that would allow them to feel that they were present with the remotely located meeting participant. “Telepresence” refers generally to a set of technologies which allow a person to feel as if they were present, to give the appearance that they were present, or to have an effect, at a location other than their true location. Telepresence generally requires that the senses of the user, or users, are provided with such stimuli as to give the feeling of being in that other location. Additionally, the user(s) may be given the ability to affect the remote location. In this case, the user's position, movements, actions, voice, etc. may be sensed, transmitted, and duplicated in the remote location to bring about this effect. Therefore, information may be traveling in both directions between the user and the remote location.

Current commercially available telepresence technology is available from Digital Video Enterprises (DVE), Polycom, HP, Cisco, Telanetix, Tandberg, BrightCom, LifeSize, and Teliris. These systems are of varying effectiveness in making a viewer feel as if he was present in the same place as a remotely located meeting participant. Moreover, prices for such systems range from $10,000's to $100,000's. These systems are expensive due to the fact that they include fairly complex arrangements of not inexpensive technology to such as, for example, multiple microphones, speakers, high definition monitors, cameras, and often dedicated networks and custom-made studios. These systems strive to be as transparent to users as possible by providing life-size videos, imperceptible transmission delays, and user-friendly interfaces, facts which likely account for the high cost of these systems.

While existing telepresence systems can be effective in improving the feeling that remotely located meeting participants are present together so as to improve the perceived quality of the meeting, the cost of such systems put them out of reach of many users. Moreover, such systems are generally not transportable, which limits their ability to be widely adopted by more people who might find telepresence useful.

Further, persons who teach or speak often use overhead projectors to enhance the quality of their presentations, such as by displaying documents or objects to their audience. If a person travels to speak and teach, he might find it necessary to transport an overhead projector to the location where he is speaking or teaching. However, existing overhead projectors and digital projectors, although marketed as “portable,” generally are somewhat large. This makes it difficult for someone to easily travel with these devices, especially today when commercial airlines significantly restrict the number of bags that can be carried on board.

For the above reasons, there is a need for improved systems, components therefor and methods to conduct meetings, both in person and remotely.

### SUMMARY OF THE INVENTION

In various exemplary embodiments, the technology described herein provides a system, components, and methods for viewing documents or objects using a webcam.

In one exemplary embodiment, the technology described herein provides a n image sensor support device comprising a foot assembly releasably coupled with respect to a base and an image sensor mount rotatably coupled with respect to the foot assembly. The image sensor mount can be rotatably secured to an elongated stem assembly and the stem assembly can be rotatably secured to the foot assembly. The stem assembly can rotate vertically with respect to the foot assembly. The foot assembly can comprise a planar body and a pair of parallel vertical walls extending perpendicularly with respect to the planar body. The stem assembly can be rotatably secured with a fastener releasably secured with respect to apertures located within each parallel vertical wall. The planar body can be releasably secured to a base with a fastener. A channel can extend the entire length of the stem. The stem assembly can comprise a lower boom and at least one upper boom. The stem assembly is capable of transitioning between a storage state and an in-use state. A channel can extend the entire length of the lower boom, and at least one upper boom is capable of being inserted within the lower boom channel. The image sensor mount can comprise an elongated neck secured to a mounting plate. And, the elongated neck can be rotatably coupled with respect to the stem assembly.

In a second exemplary embodiment, the technology described herein provides an image sensor support device comprising an elongated stem assembly rotatably coupled with respect to a body and an image sensor mount rotatably coupled with respect to the stem assembly. The stem assembly can comprise a lower boom and at least one upper boom. A channel can extend the entire length of the lower boom. At least one upper boom can comprise dimensions sufficient to fit within the lower boom channel. At least one bumper can partially extend across the lower boom channel. A foot assembly can be rotatably coupled with respect to the stem assembly. And, the foot assembly can be releasably coupled with respect to the body.

In a third exemplary embodiment, the technology described herein provides an image sensor support device comprising a cradle rotatably coupled with respect to an arm and a stem assembly rotatably coupled with respect to the arm. The stem assembly can be rotatably coupled with respect to a base. The cradle can comprise a pair of image sensor grips mounted to opposing sides of a rib system. The base can be a foot assembly releasably coupled with respect to a body.

There has thus been outlined, rather broadly, the more important features of the technology in order that the detailed description thereof that follows may be better understood, and in order that the present contribution to the art may be better appreciated. There are additional features of the technology that will be described hereinafter and which will form the subject matter of the claims appended hereto. In this respect, before explaining at least one embodiment of the technology in detail, it is to be understood that the invention is not limited in its application to the details of construction and to the arrangements of the components set forth in the following description or illustrated in the drawings. The technology described herein is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the technology described herein. It is important, therefore, that the claims be regarded as including such equivalent constructions insofar as they do not depart from the spirit and scope of the technology described herein.

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description of the invention are exemplary and explanatory of preferred embodiments of the invention, and are not restrictive of the invention, as claimed.

### BRIEF DESCRIPTION OF THE DRAWINGS

The technology described herein is illustrated with reference to the various drawings, in which like reference numbers denote like device components and/or method steps, respectively, and in which:

FIG. 1 is a schematic diagram of a system for viewing documents or objects, shown in use with a plurality of components.

FIG. 2 is a front perspective view of the first example embodiment system in use with a computer.

FIG. 3 is a front perspective view of the example system according to the embodiment depicted in FIG. 2, showing the rotation of the web-cam.

FIG. 4 is front perspective detail view of a portion of the example system of FIG. 2, showing an example telescopic stem assembly.

FIG. 5 is a perspective view of the example system components according to the embodiment depicted in FIG. 2, shown in a disassembled state.

FIG. 6 is a perspective view of the stem assembly according to the embodiment depicted in FIG. 2.

FIG. 7 is a perspective view of a first alternative example stem assembly.

FIG. 8 is a perspective view of a second alternative stem assembly.

FIG. 9 is a perspetive diagram of a second example embodiment system for viewing documents or objects, shown in use with a variety of example components.

FIG. 10 is an isolated perspective view of the example system according to the embodiment depicted in FIG. 9, shown in use with a computer.

FIG. 11 is a side view of the system according to the example embodiment depicted in FIG. 9, shown in use with a weighted base and a webcam.

FIG. 12 is a top view of the system according to the example embodiment depicted in FIG. 11.

FIG. 13 is a front view of the system according to the example embodiment depicted in FIG. 11.

FIG. 14 is an exploded perspective view of the system according to the example embodiment depicted in FIG. 11.

FIG. 15 is a perspective view of the components of the system according to the example embodiment depicted in FIG. 11, shown dissassembled in a storage state.

FIG. 16 is a perspective view of the example embodiment system depicted in FIG. 11, shown in use mounted to a tri-pod without the base.

FIG. 17 is a perspective view of the example system according to the embodiment depicted in FIG. 11, shown in use with the clamp secured onto a horizontal surface, without the base.

FIG. 18 is a perspective view of the example system according to the embodiment depicted in FIG. 17, shown secured onto a vertical surface.

FIG. 19 is a side view of the example system according to the embodiment depicted in FIG. 11, shown in use with an alternative cradle for securing a smart-telephone.

FIG. 20 is an isolated top rear perspective view of an example embodiment cradle according to the alternative example embodiment depicted in FIG. 19, shown in use securing a smart-telephone.

FIG. 21 is a top front perspective view of the example cradle according to the example embodiment depicted in FIG. 20.

FIG. 22 is an underneath perspective view of the example cradle according to the example embodiment depicted in FIG. 20.

FIG. 23 is a perspective view of the example cradle according to the example embodiment depicted in FIG. 20.

FIG. 24 is a top perspective view of the example cradle according to the example embodiment depicted in FIG. 20, shown without a smart-telephone.

FIG. 25 is an underneath perspective view of the example cradle according to the example embodiment depicted in FIG. 24.

FIG. 26 is an exploded perspective view of the example cradle according to the example embodiment depicted in FIG. 24.

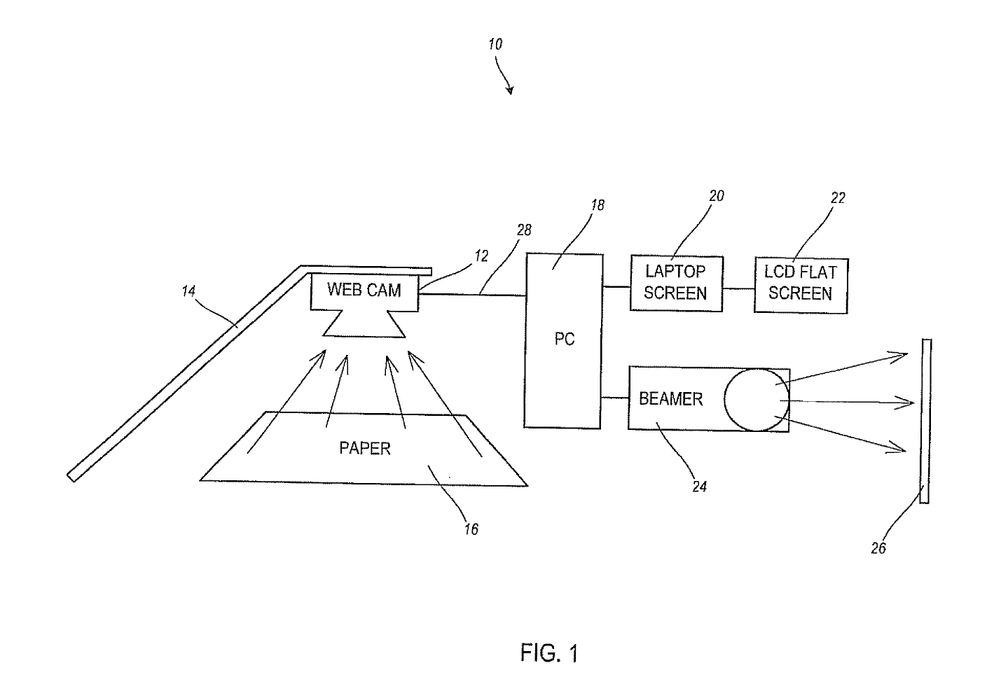

### DETAILED DESCRIPTION OF EXAMPLE EMBODIMENTS

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

Referring now to the Figures, in various exemplary embodiments, the technology described herein provides a system 10, components, and methods for viewing documents 16 or objects using a webcam 12. The system is small, lightweight, portable, and easy to mass manufacture with minimal moving parts. The system 10 is configured to be assembled very rapidly, typically in less than fifteen seconds.

A “webcam” 12 is a video camera connected to a computer 18 or other suitable device so that its output may be viewed, either directly on a display unit or transmitted over the Internet, cellular telephone, etc. Additionally, other types of picture and video capture devices, whether existing today or developed in the future, are suitably used as a component in the system 10 disclosed herein, as long as such picture or video capture device is capable of being repositionably attached to the support device 14 disclosed herein and is also capable of transmitting pictures or videos to display unit as defined elsewhere herein. To be suitable for use, the video or picture capture device, i.e., the webcam 12 (as the term is defined herein), has the ability to provide the picture or video in digital form (either directly or through conversion) to a display unit suitable for viewing the picture or video.

“Display unit” means the device upon which a viewer observes the video or pictures captured by the webcam 12 used in the system 10 of the technology described herein, such as for example, a laptop screen 20, LCD flat screen 22, or projector screen 26. The display unit can be, for example, a computer, digital projector 24, Smartphone, PDA, television, computer monitor, extended monitor, video projector, and the like, configured to accept a video or picture signal captured by the webcam 12 via a wired 28, e.g. USB, such as 48, or the like or a wireless connection.

In relation to the support device 14 used to support the webcam 12 during use, “repositionably attached” or “repositionably attachable” means that the webcam 12 can be attached and reattached to the support device 14 as needed and desired by the user.

“Remotely located viewer” means a viewer who views a video or picture captured by a webcam 12, where the picture or video is transmitted by signal to viewer in another location from the person conducting the meeting. When a remote viewer is attending a meeting, the signal from the webcam 12 is transmitted via the Internet or by device suitable to transmit a picture and/or video from the webcam. Examples of such suitable transmission devices can comprise, in non-limiting examples, a PDA e.g. I-Phone® or a Blackberry®, or a Smartphone.

In one aspect, the technology described herein comprises a system 10 for capturing video and/or pictures of documents, objects or the like using a webcam, as this term is defined elsewhere herein. In pertinent part, the system 10 comprises a support device 14, wherein the support device 14 allows repositionable attachment of the webcam 12 thereto. The system 10 can also comprise a display unit, such as screens 20, 22, 26 for example, capable of accepting videos and/or picture signals from the webcam.

A significant feature of the technology disclosed herein is that the system 10 allows anything placed within the visual frame of the webcam 12 to be transmitted either to an in-person audience or to a remote viewer substantially in real time and/or captured for later viewing.

In one aspect, the technology described herein can be used to facilitate in person meetings—that is, when a speaker is in the same room as the audience—by allowing a speaker to easily show documents, such as paper 16, or objects to an audience in real time. In such an aspect, the technology described herein provides a highly portable and flexible substitute for a traditional overhead projector system. Specifically, unlike traditional overhead projector systems, the system 10 of the technology described herein typically weighs less than about one pound and can be set up for use very quickly. Moreover, unlike traditional overhead projectors, the system 10 of the technology described herein allows video and pictures to be captured for later review.

In a particularly useful aspect of the technology described herein, writings or edits made by hand can be made to a document or permanent markings can be made to an object, where such writings, edits and markings can be viewed substantially in real time by the audience. The ability of a group to view such activities improves the ability of others to verify that the document or object is an authentic version thereof at a later time. As one example of this aspect, edits can be made to a contract to be viewed by a group in a meeting setting, and those changes can be verified later through review of a video capture of the edits. Still further, in an auction setting, an object can be marked such as by the auctioneer to demonstrate to a group that a buyer purchased that particular object. The buyer can later authenticate the identity of the object by comparing the marking made as shown in the video with the marking on the actual object. In yet a further example, Bible study can be conducted in a group setting to demonstrate to an audience the place in the Bible from which the study leader is reading. This can be recorded for later playback.

To operate in the facilitation of in person meetings, the videos and/or pictures captured from the webcam 12 that is repositionably attached to the support device 14 can be transmitted via wired 28 or wireless connection to, for example, a computer 18, PDA, Smartphone or digital projector 24 for viewing by the audience. The videos and/or pictures can be viewed in real time or can be recorded (or otherwise “time shifted”) for playback at a later time.

The software used to transmit captured video or pictures from the webcam 12 repositionably mounted on the support device 14 to the display unit e.g. computer 18, PDA, Smartphone, television or digital projector 24, is not currently believed to be critical to the technology described herein. As such, when the webcam 12 is repositionably mounted on the support device 14 the software provided with the webcam 12 to allow capture or display of the captured pictures or video can suitably be used.

In a further aspect, the technology described herein facilitates meetings where at least two of the participants therewith are located in different locations. In this case a remote viewer is able to see a document or object in real time as that document or object is, for example, discussed, marked or edited by someone present therewith. The system 10 of the technology described herein is highly flexible and can be used to capture images for transmission to remote user or captured for later review such as, almost any document form and size, book, contract or notes. In a particularly useful aspect of the technology described herein, notations can be transmitted to a remote viewer in substantially real time or captured for later viewing.

In a pertinent example of this aspect of the system 10 of the technology described herein, edits to drawings can be captured by the webcam 12 and transmitted to a remote user in substantially real time or captured for later viewing. In a further pertinent example, brainstorming can occur between participants in different locations. The flexibility of the system 10 of the technology described herein allows such remotely located users to both take notation and directly communicate with the other participants.

To allow a remote viewer to observe a document or object while being discussed or described by a speaker in another location, standard peer-to-peer meeting software can be used to transmit the captured video or pictures. Such software includes branded products such as WebEx® (owned by Cisco Corporation), Go to Meeting® (owned by Citrix) and Skype®. When the system 10 is used for a remote meeting, software that allows a user to view split or dual screens can provide tremendous benefits because a presenter can show a document 16 or object while still maintaining a conversation with a viewer located away from the presenter. For example, the presenter can orient him or herself to one webcam 12 while at the same time capturing a picture or video with the webcam repositionably attached to the support device 14. As one example, a teacher can provide real time edits to a student's class assignments while the student watches from a remote location by using the webcam 12 repositionably attached to the support device 14 while at the same time the teacher is speaking directly to the student through a second webcam 12 positioned at eyelevel.

Still further, the system 10 of the technology described herein can be used to demonstrate aspects of an object to a remote viewer or captured for later viewing. For example, a remote viewer can be shown aspects of an object for purchase. As one example of this aspect, a merchant can show a remote purchaser a product using the system 10. For products having unique features, such as antiques, art, coins or the like, the seller can identify the object using some sort of security device while the purchaser is watching in real time, such as a seal or signature etc. When the purchaser receives the object, he can compare the security feature captured using the system 10 of the technology described herein with the security feature present on the product as received. This provides the purchaser with proof that the product received is the actual product requested from the remote seller.

In one aspect, the support device 14 permits repositionable attachment of a webcam 12 thereon, where the support device 14 and webcam 12 comprise a significant aspect of the system 10. Significantly, the support device 14 allows the webcam 12 to be repositionably attached so as to substantially prevent environmental sources of vibration from being transmitted to the webcam 12. It should be noted that many webcams 12 (as well as other modern video capture devices) include software that provides digital picture stabilization to reduce or eliminate shaking of the picture when viewed. The stabilization provided by the support device 14 of the system 10 of the technology described herein is distinguishable from such software-derived picture stabilization. In other words, the webcam 12 attached to the support device 14 of the technology described herein is isolated or substantially isolated from environmental sources of vibration due to the shape and composition of the support device 14 and the way the webcam 12 is attached to the support device 12. The technology described herein therefore allows stable viewing of a picture or video from a webcam 12 even if digital picture stabilization is absent or substantially absent from the webcam 12 or other picture or video capture device.

The support device 14 of the system 10 of the technology described herein can be prepared from metal, plastic or any other suitable material. Since the support device 14 is intended to easily transportable by a user, it can be desirable to prepare the support device 14 out of a lightweight material. If metal is used, the support device 14 can be suitably prepared out of aluminum or other lightweight metal. If plastic is used to prepare the support device 14, the plastic should be strong and rigid enough to support a webcam 12 thereon. Moreover, regardless of the material used to prepare the support device 14, the device should be fabricated so as to substantially prevent environmental sources of vibration from being transmitted from the surface upon which the support device 14 is mounted to the webcam 12. This feature of the support device 14 can significantly improve the functionality of the system because the webcam is effectively isolated from any vibration in the environment.

In one aspect, the support device 14 can comprise an approximately z-shaped (whether oriented correctly or in reverse) structure fabricated out of suitable material (as discussed elsewhere herein), wherein the structure comprises an upper projection 52 and a lower projection 50, wherein the upper and lower projections 52, 50 are each joined at one end to a stem 54. The upper and lower projections 52, 50 can be oriented as depicted in the Figures.

Moreover, the orientation of the upper and lower projections 52, 50 of the support device 14 in relation to each other and each to the stem 54 also comprises a notable aspect of some aspects of the technology described herein. The inventor has found that when the lower projection 50 is substantially flat against a substantially flat surface, a webcam 12 attached to the support device 14 having a stem 54 oriented at an approximate 45 degree angle to the lower projection 50 provides substantial flexibility in use. The upper and lower projections 52, 50 can each, independently, be oriented in a bent, offset or twisted orientation in relation to the stem 54. Specifically, the approximate 45 degree angle allows the webcam 12 to be moved along the stem 54 at substantially any location and still be oriented to allow the webcam 12 to be used to visualize both large and small documents and objects.

In a further aspect, the stem 54, and consequently the distance by which the upper and lower projections 52, 50 are separated, can be of any suitable length to allow capture of pictures or video using a webcam repositionably attached thereto. For example, when viewing large documents 16 (such as schematics or architectural drawings), a longer stem 54 can allow visualization of the entire document 16 in a single visual frame. Similarly, a shorter stem 54 can allow visualization of a smaller document in a single visual frame. If a longer stem 54 is used, a webcam 12 repositionably attached to the stem 54 can be virtually infinitely repositioned along the length of the stem 54 to allow pictures and videos of documents and objects of various sizes without separately adjusting the focus or orientation of the webcam 12. This allows the user to focus on his or her conversation or presentation with the remote viewer, rather than needing to repeatedly refocus the camera 12 to obtain a clearer or close-up picture.

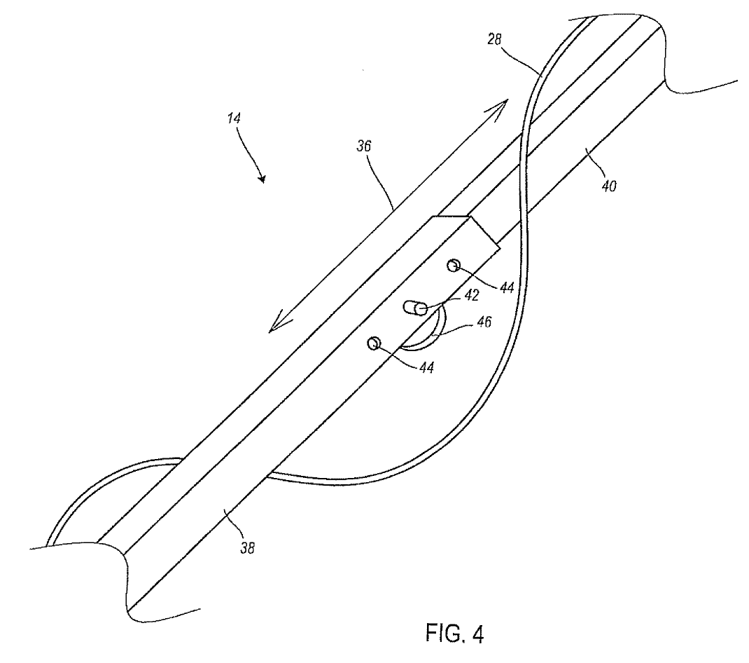

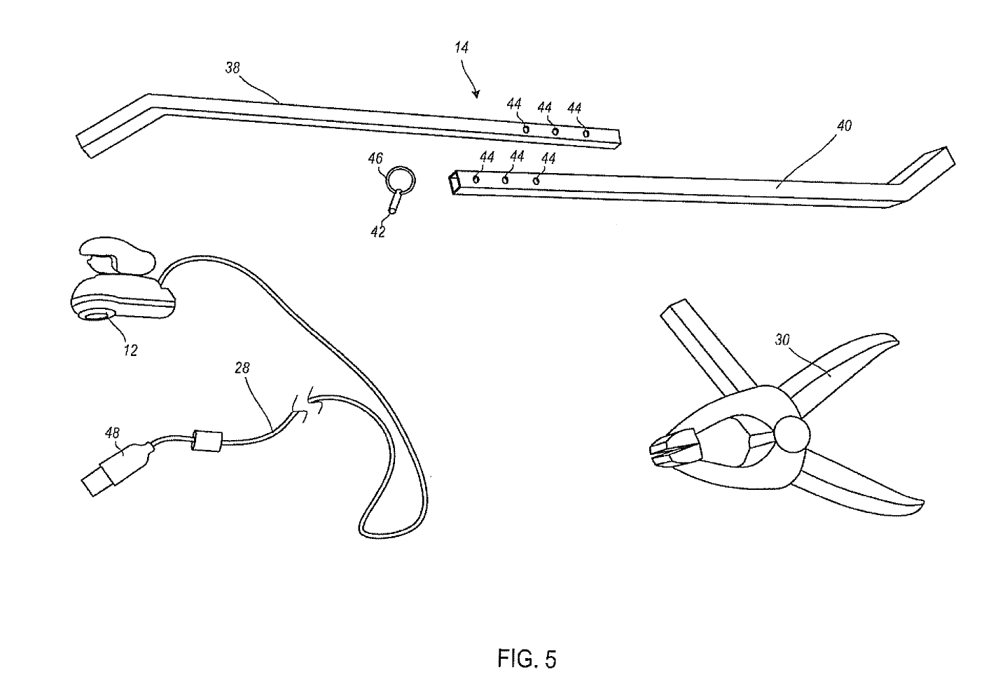

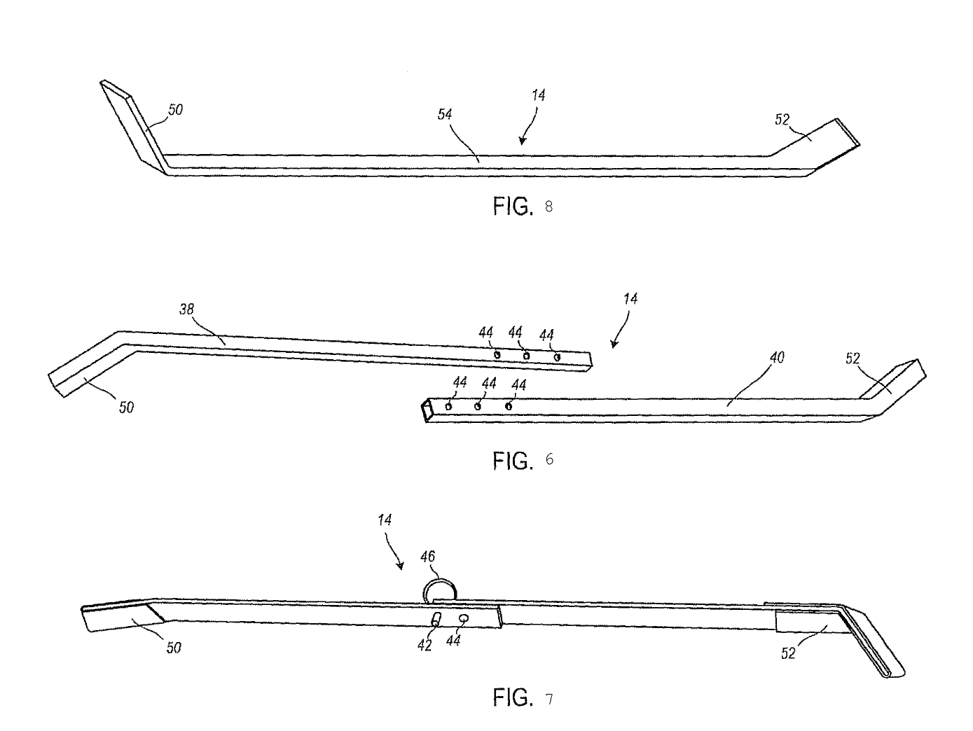

Yet further, the support device 14 can be disassembled to improve the portability of the system 10 of the technology described herein. To this end, the stem 54 can be comprised of at least two separate parts, such as a lower stem 38 and an upper stem 40, that are connected by as fastener. Examples of suitable fasteners include, for example, a screw or a cotter pin 44 or the like. Pin 42 can be grasped by ring 46 and placed through pin hole 44 to secure the lower stem 38 and the upper stem 40 one to another. As such a telescoping effect is created, as shown, for example, by telescoping direction 36, as depicted specifically in FIG. 4. For storage and transport, the at least two parts 38, 40 of the stem 54 can be rotated on an axis (such as that resulting from a circular connector substantially permanently attaching the at least two parts) so that the at least two parts 38, 40 of the stem 54 substantially nest so as to reduce the overall length of the stem 54. For use, the at least two parts 38, 40 of the stem 54 can be rotated on the axis and fastened or locked to provide an assembled support device 14 comprising the at least two parts.

In a further method to permit disassembly the support device 14 to improve portability, a groove or pin hole 44 can be present in one or more of the at least two parts 38, 40 of the support device 14. One or more screws or other type of fastener 42 can be used to assemble the at least two parts 38, 40 of the support device 14. The support device 14 can be lengthened and shortened for use and portability by re-positioning the location of the fastener 42 as appropriate.

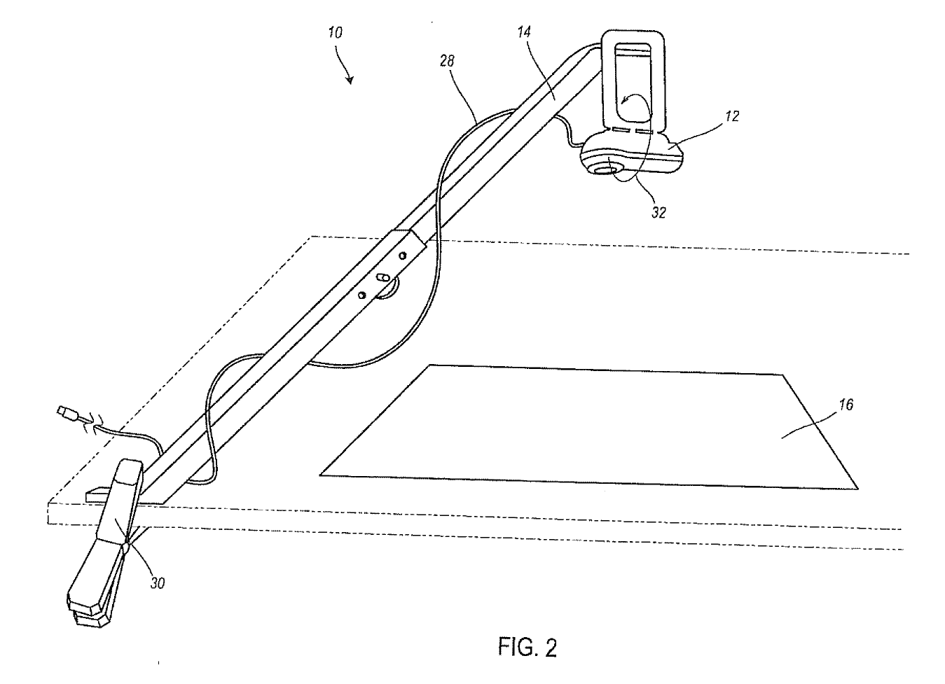

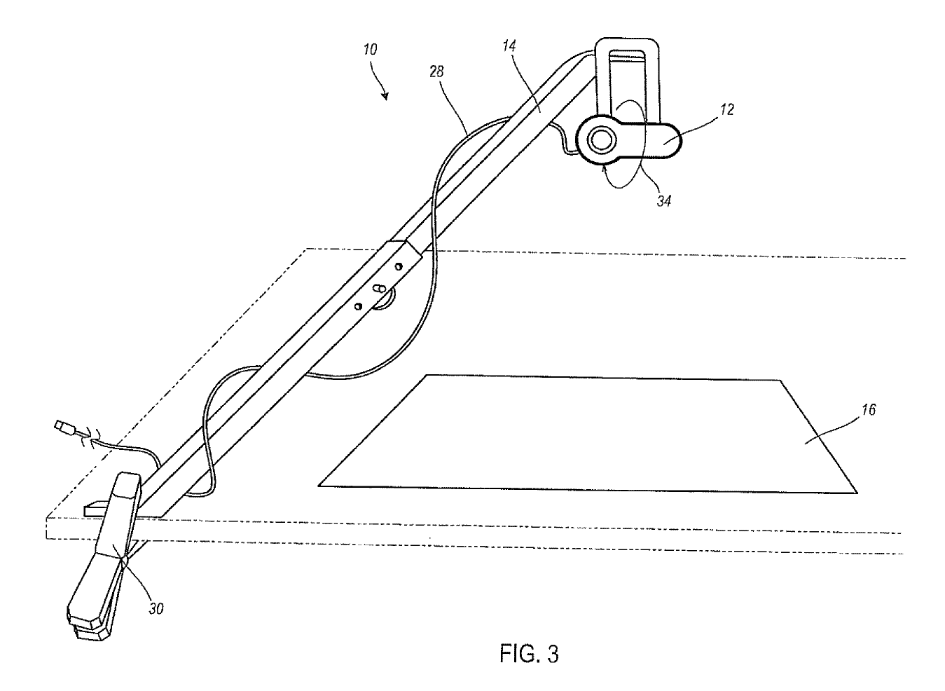

In a significant aspect, when the webcam 12 is repositionably attached to the support device 14, the user is able to rotate the webcam 12 substantially throughout a 360 degree orientation without dismounting the webcam 12 from the support device 14. Rotation can include, for example, rotation in direction 32, as depicted in FIG. 2. Similarly, rotation can include, for example, rotation in direction 34, as depicted in FIG. 3. Moreover, such rotation can occur substantially without distortion of the picture quality because the lower projection allows the webcam 12 to effectively glide smoothly along a substantially flat surface such as a table or lectern. The substantial non-distortion is accomplished as a result of the orientation of the support device 14 having the webcam 12 repositionably attached with the surface upon which the support device 14 is situated.

The webcam 12 can be repositionably attached to the support device 14 using one or more attachment methods. Repositionable attachment of the webcam 12 to the support device can be accomplished using a hook and eye system e.g. Velcro® wherein the hook part is securely attached to the stem and upper projection of the support device and the eye part is securely attached to the webcam (or vice versa). Additionally, the stem 54 and upper projection 52 of the support device 14 can be configured to allow the webcam 12 to be attached by inclusion of repositionable attachment directly onto the support device 14. For example, the webcam 12 can be configured with a magnetized aspect to allow repositionable attachment to the stem 54 and upper projection 52. Still further, the stem 54 and upper projection 52 can include grove functionality and the webcam 12 can include tongue functionality (or vice versa) so that the webcam 12 can be moved along the surface of the support device 14 to allow the webcam 12 to be repositionably attached thereto. Yet further, the upper projection 52 and stem 54 can be configured in any manner that allows the webcam 12 to be repositionably attached thereto.

The support device 14 (whether or not the stem 54 is comprised of one part or at least two parts) can comprise the repositionable attachment e.g., Velcro, along the entire length or along only a part of the length of the stem 54. For example, when the stem 54 comprises two parts rotatable on an axis, the repositionable attachment can be included substantially on one part of the stem 54. In such an aspect, the repositionable attachment may extend along a top side, a lower side or both of the upper projection 52 to permit the webcam 12 to be mounted thereon to provide enhanced viewing range in use.

In a further aspect, the support device 14 (whether or not the stem is comprised of one part or at least two parts) can include the repositionable attachment on an upper and lower side of the stem 54. For example, when the stem 54 comprises at two parts 38, 40, the upper part 40 of the stem 54 can include Velcro along its upper length and continuing to the top side of the upper projection 52. The Velcro can also be present on the bottom side of the lower projection 50 and, optionally, continuing down the bottom side (that is the side facing away from the other side) of the first part of the two part stem.

In use, the support device 14 having a webcam 12 repositionably attachable thereto is itself attached to a substantially flat surface, such as a table or lectern or other suitable surface, using a clamp 30 or any other suitable fastener. The method of fastening the support device 14 to a substantially flat surface is not currently believed to be significant to the operation of the technology described herein. However, in order to suitably isolate the webcam 12 from environmental vibration so as to provide a substantially distortion free picture or video, the support device 14 should be substantially rigidly fastenable to the substantially flat surface. In other words, loose fastening of the support device 14 to a table, lectern or other mounting surface will make it more likely that environmental sources of vibration will be transmitted to the webcam 12, which could decrease the quality of the picture or video obtained from the webcam 12.

Without being bound by theory, the inventor herein believes that the angle and orientation of the support device 14 effectively assist in dissipating environmental vibrations before such vibrations can reach the webcam 12. Accordingly, it is currently understood that the support device 14 allows the webcam 12 to capture videos and/or pictures without substantial distortion thereof, where such lack of distortion is substantially independent of any anti-distortion software associated either with the webcam 12 or an attendant display unit.

A further component of the system 10 of the technology described herein is a webcam 12 or other device that can capture or transmit pictures or video depictions of objects as defined elsewhere herein. While a webcam 12 today comprises a highly suitable device for use in the system 10, it is expected that other devices will be useable with the technology described herein. The device used to capture a picture or video of the object is not believed to be critical to the functionality of the technology, as long as the device can be suitably repositionably attached to the support device. When a webcam 12 is used, high resolution devices typically are beneficial. Webcam 12 technology is improving rapidly, as such it is expected the suitable webcams (as well as other devices) will change substantially in the not-too-distant future. However, at the present time, a highly suitable high definition webcam 12 for use as a component in the system 10 is made by Logitech under the 9000 Pro brand, the C905 notebook web camera, and the C910 webcamera.

If the webcam 12 comprises a wired connection to transmit the pictures or video, the support device 14 can be configured to allow suitable concealment or containment of the cord to assist in ease of use of the system 10. Such concealment or containment can be by clips or other type of fastener, or the support device 14 can comprise a way to allow the cord 28 to be integrated into the support device 14 itself.

The system 10 of the technology described herein shows particular utility wherever an overhead projector or digital projector can be used. Moreover, the system 10 can also be used to as a highly portable document scanner. Still further, the system 10 can be used to improve the quality of remote meetings. In such aspect, the person conducting the meeting can speak directly to the remote viewer using the one webcam 12 (such as the webcam 12 embedded within or attached to the computer 18) while using the system 10 to display documents or objects in a separate window. The system 10 therefore allows the feeling enhanced engagement of remote viewers with the person conducting the meeting and the information that is being discussed therein. Significantly, the improved meeting quality is possible at substantially less expense than currently available with telepresence technology existing today.

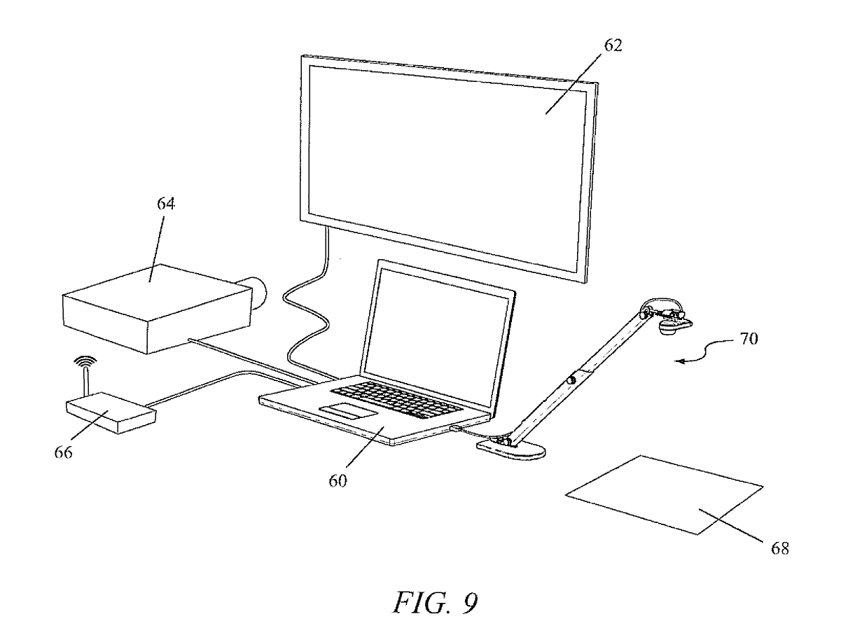

FIG. 9 represents a second example system 70 for viewing and capturing the image(s) of a document or object 68 and transmitting the viewed image(s). The system 70 can communicate with a variety of mechanisms, for example a computer 60, to display sensed or captured images on an output display device such as a computer monitor, and a television screen 62. The system 70 can alternatively be in communication with a projector 64 so that the images transmitted can alternatively be projected from the projector 64 onto a surface. The images can alternatively still be transmitted through an Internet router 66 and received by remote network users. The system 70 can communicate with these devices 60, 62, 64, 66 through a cord (e.g., USB) or through wireless communication. Alternatively, the system 70 can be operatively in communication directly with one or more of these or other output display devices.

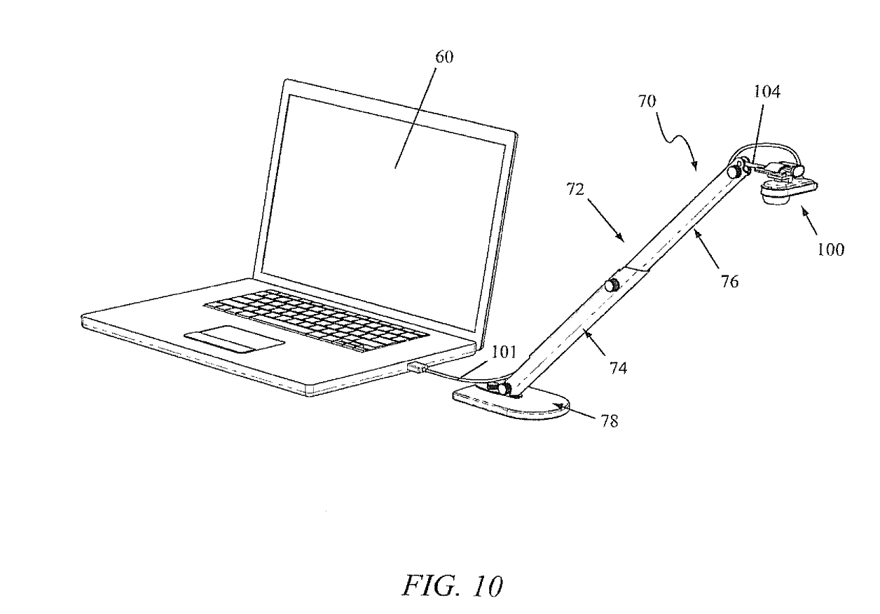

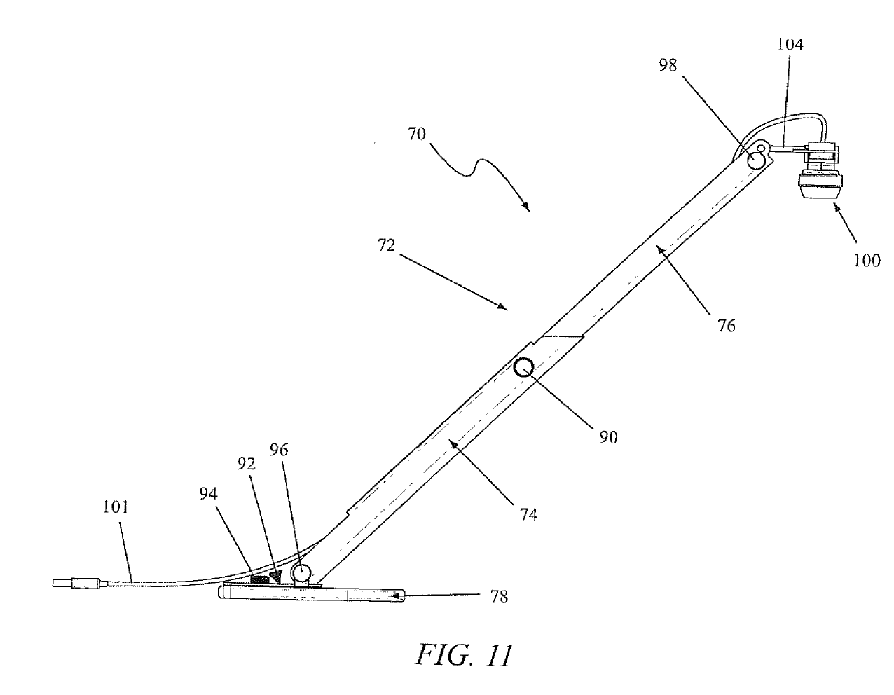

FIG. 10 represents the example system 70 communicating specifically with a computer 60 through a cord 101. The example system 70 includes an elongated stem assembly 72, which includes a lower boom 74 and an upper boom 76. An example image sensor 100 is secured to the example system 70 with an example image sensor mount 104. The example image sensor 100 can capture an image of a document or object 68 (shown in FIG. 9) and transmit the image, as described above. An example image sensor 100 is shown to be a web-camera, for example a web-camera manufactured by LOGITECH. The example stem 72 is represented to be vertically supported by an example base 78.

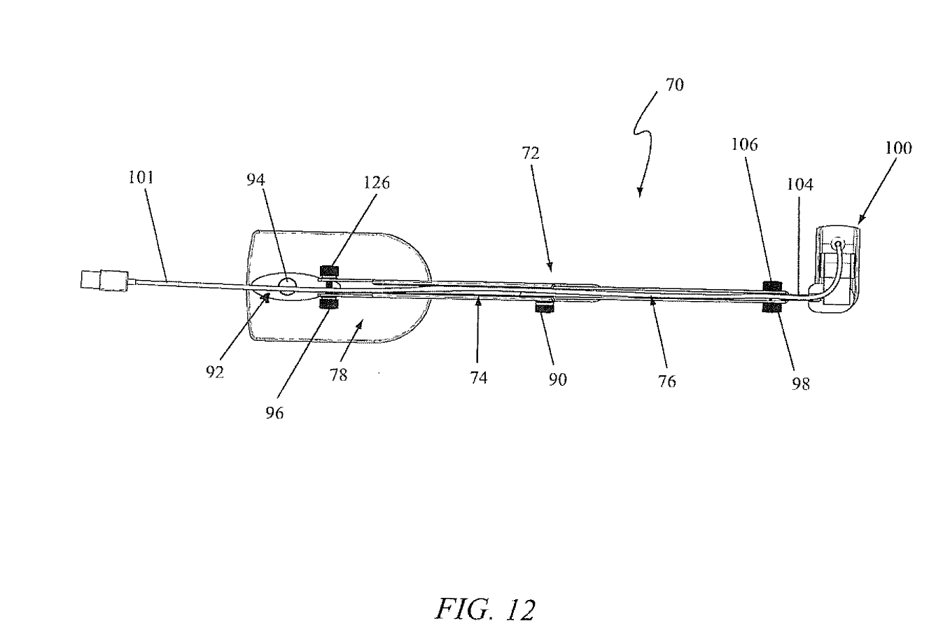

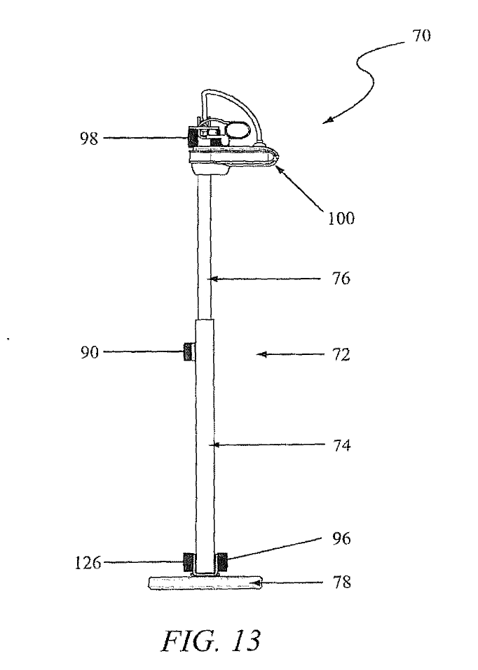

As shown in FIGS. 11-19, the example system 70 includes an adapter assembly 92. The adapter assembly 92 can include a generally planar mounting foot with a top surface and a bottom surface. The example foot can be elongated and/or oval-shaped. The foot includes at least one aperture 91. This aperture 91 can be centered along a longitudinal axis extending the entire length of the foot. At least one (e.g., the depicted pair of parallel opposing vertical) wall extends vertically upward from the foot. The depicted vertical walls are located on the top surface of the foot, in positions opposite of the aperture 91 along the length of the foot. Each of the perpendicular walls can include a pivotal coupling component (e.g., the depicted aperture 93) that aligns vertically and horizontally with the opposing wall pivotal coupling component. The adapter assembly 92 is constructed of a durable and rigid material, for example plastic or aluminum.

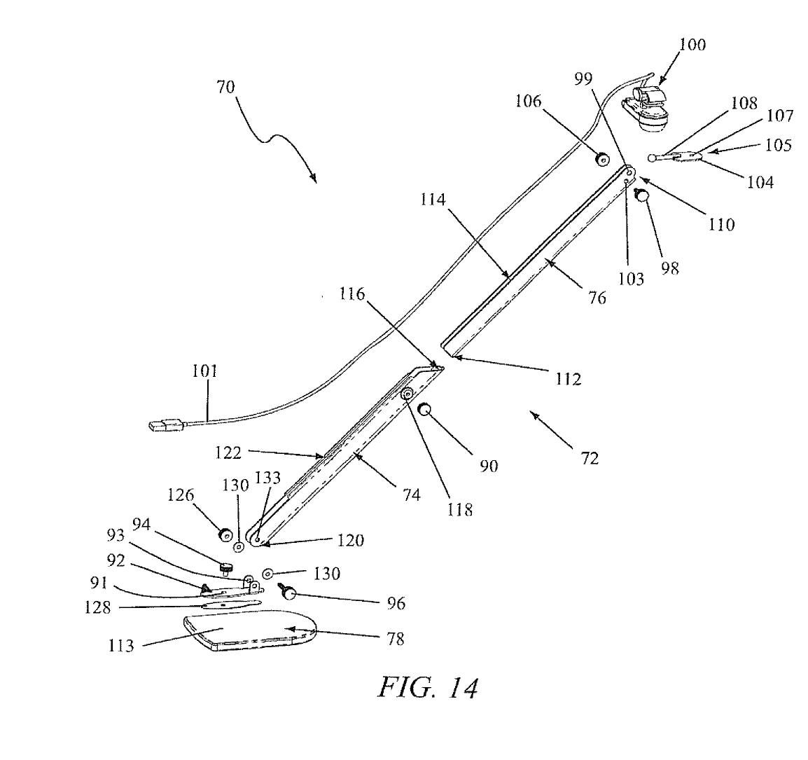

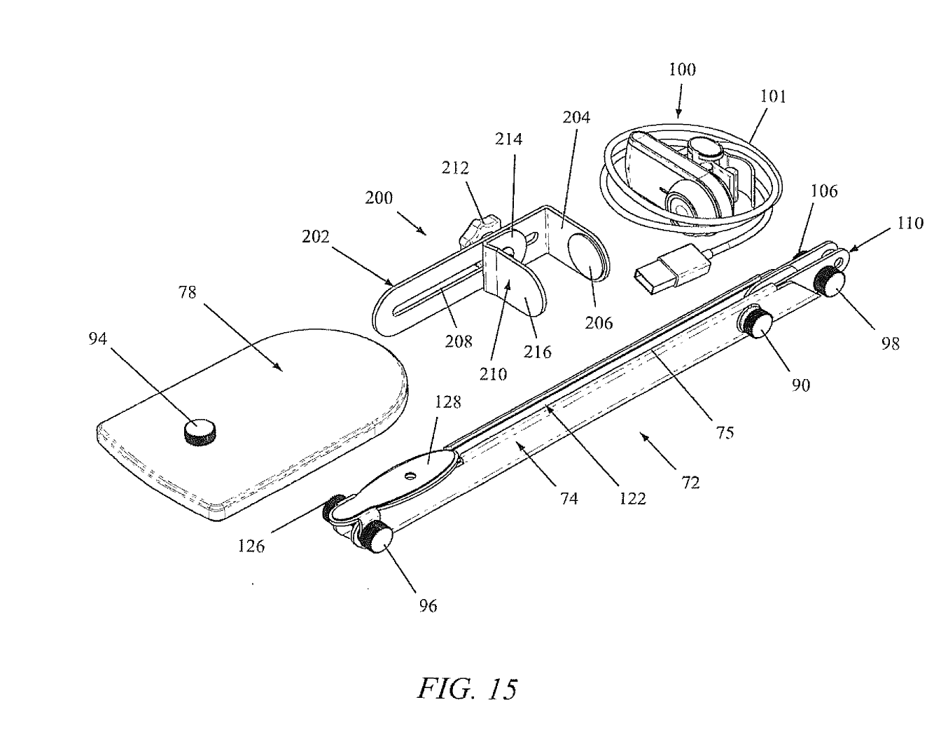

A support 128 can be secured to the bottom surface of the foot 92 (FIGS. 14-15). The example support 128 can include a planar structure having a size and shape generally conforming to the bottom surface of the foot of the adapter assembly 92. The support 128 can be made of a rigid plastic material or a soft sponge-like material and can be secured to the bottom surface of the foot 92 with an adhesive.

As further shown in FIGS. 11-19, the system 70 includes a stem 72 secured to the adapter assembly 92. The depicted example stem 72 includes a lower boom 74 and an upper boom 76. Alternatively, additional booms can be included. The lower boom 74 and upper boom 76 are constructed of rigid and sturdy material, for example plastic or aluminum. The lower boom 74 is an elongated, rigid structure with open ends and an open channel 122 extending from the upper open end 116 to the lower open end 120. In a typical commercial embodiment, the lower boom 74 includes two parallel walls connected by a perpendicular floor that cooperatively define the open channel 122. The lower boom 74 can include a pair of bumpers 75 that extend inwardly from a top edge of each parallel wall. In typical embodiments, the bumpers 75 extend a majority of the length of the lower boom 74. The bumpers 75 can be inwardly bent extensions of the parallel walls and constructed of similar material. Alternatively, the bumpers 75 can be constructed of a durable material, for example plastic or rubber, and secured to the top edge of the parallel walls through an adhesive or other fastening technique.

The parallel walls of the lower end 120 of the example lower boom 74 can include semi-circular rounded edges. At the lower end 120, the perpendicular foot connects to the two parallel walls at the lowest point on each of the semi-circular rounded edges. Therefore, the midpoint of each semi-circular rounded edge circumference extends longitudinally beyond the perpendicular foot. Each of the parallel walls includes a pivotal coupling component (e.g., the depicted aperture 133 located at the center of the radius of the semi-circular rounded edges).

The distance between the example semi-circular rounded edges of the lower boom 74 is slightly wider than the distance between the parallel vertical walls of the example adapter assembly 92 (or vice versa). In use, the semi-circular rounded edges of the lower boom 74 are aligned outside of the parallel walls of the foot 92. The apertures 133 align with, and are outside of, the apertures 93 of the parallel walls of the foot 92. A pivotal coupling component (e.g., the depicted fastener) secures the lower boom 74 to the foot 92. For example, the fastener can include a threaded screw 96 inserted through the apertures 133 of the example lower boom 74 and the apertures 93 of the example adapter assembly 92 and secured with a correspondingly-threaded nut 126. Additionally, a pair of washers 130 can be inserted between the walls of the example adapter assembly 92 and the walls of the example lower boom 74 to increase stability. While a forty-five degree angle is optimal, the angle between the foot of the adapter assembly 92 and the length of the example lower boom 74 can be changed by loosening the example fastener 96 and rotating the lower boom with respect to the foot. Once a preferred position is achieved, the example fastener 96 is re-tightened. Alternatively, the fastener 96 can operate as an angle adjustment knob. A user can turn the adjustment knob 96 in either direction to correspondingly alter the angle of the lower boom 74. It will be understood by those skilled in the art that other pivotal coupling and adjustment mechanisms can instead be included.

Alternatively, the parallel walls of the adapter assembly 92 can have a series of individual apertures (not shown) through which a fastener can secure the aperture 133 of the lower boom 74 to varying angles with respect to the foot. Similarly, the lower boom 74 can have a series of apertures (not shown) through which a fastener can secure to the apertures 93 in the adapter assembly 92.

The upper end 116 of the example lower boom 74 includes an opening formed by the channel 122, as described above. An example opening can include forward-facing edges angled upwardly from the floor of the channel 122 toward the top of the parallel walls. The upper end 116 of the lower boom 74 can also include an aperture 118 located on at least one of the parallel vertical walls. Alternatively, each of the parallel vertical walls includes an upper end 116 aperture 118. A stopper 90 is secured within the aperture 118 and extends at least partially within the open channel 122 to prevent the upper boom 76 from sliding downwardly within the lower boom 74 during use. The stopper 90 can be temporarily removed from the channel 122 to allow the upper boom 76 to slide within the lower boom 74. An example stopper 90 can be a push pin secured with a friction fit or pinch. Alternatively, an example stopper 90 can be a threaded screw secured within a correspondingly-threaded aperture 118 in the parallel wall.

An upper boom 76 can be an elongated, rigid structure with open ends and an open channel 114 extending from an open upper end 110 to an open lower end 112. In a typical commercial embodiment, the upper boom 74 includes two parallel walls connected by a perpendicular floor that cooperatively define the open channel 114. The lower open end 112 can include a pair of apertures (not shown) aligned opposite each other at a designated position on the parallel walls. It is contemplated that in use, the stopper 90 on the lower boom 74 can insert through at least one aperture (not shown) in the lower end 112 of the upper boom 76.

The parallel walls of the open upper end 110 of the upper boom 76 can include semi-circular rounded edges. At the upper end 120, the example perpendicular foot connects to the two example parallel walls at the lowest point on each of the semi-circular rounded edges. Therefore, the midpoint of each semi-circular rounded edge circumference extends longitudinally beyond the perpendicular foot. Each of the parallel walls includes an aperture 99 located at the center of the radius of the semi-circular rounded edges.

A second pair of apertures 103 can be located on the parallel walls at a point further away from the upper end 110 than the apertures 99 in the semi-circular rounded edges. A clamp 98 is secured with respect to the second pair of apertures. The clamp 98 can apply pressure to decrease the distance between the parallel walls. Alternatively, the clamp can be released to increase distance between the parallel walls. An example clamp 98 threaded screw that is secured with a correspondingly-threaded nut 106.

The width between the parallel walls of the example upper boom 76 is slightly less than the width between the parallel walls of the example lower boom 74 (or vice versa). The height of the parallel walls of the example upper boom 76 is slightly less than the height of the parallel walls of the example lower boom 74 (or vice versa). The lower boom 74 can be made of a heavier material than the upper boom 76 (or vice versa). In storage, as shown in FIG. 15, the lower end 112 of the example upper boom 76 slides within upper end 116 of the example lower boom 74 (or vice versa). In use, as alternatively shown in FIGS. 11-13, the lower end 112 of the example upper boom 76 slides into the upper end 116 of the example lower boom 74 until the lower end 112 is stopped by the stopper 90 extending through the aperture 118. Within the example lower boom 74, the parallel walls of the example upper boom 76 are secured between the lower boom floor and the bumpers 75. The bumpers 75 prevent the free length of the upper boom 76 from rotating downward with respect to the lower boom 74.

An image sensor mount 105 can be secured to the upper end 110 of the example upper boom 76. An example images sensor mount 105 includes a neck 108 and a mounting plate 104. The example neck 108 includes spherical structure secured to the end of a connection arm. For example the spherical structure can represent a ball in a ball joint. The example spherical structure has a diameter slightly larger than the distance between the semi-circular rounded edges of the upper end 110 of the example upper boom 76. In use, the spherical structure of the example neck 108 is wedged into a friction fit between the apertures 99 located in these semi-circular rounded edges. Once, secured within the apertures 99, a ball joint is formed to provide the image sensor mount 105 with freedom of motion vertically, horizontally, and in torque motion. Further, the clamp 98 is tightened when the spherical structure is secured within the apertures 99 to prevent the spherical structured from accidentally slipping out. The clamp 98 is relaxed in order to remove the spherical structure from the apertures 99. With sufficient force, the angle of the neck 108 can be altered (vertically and horizontally) with respect to the example upper boom 76. And, with sufficient force, the neck 108 can be rotated in a torque direction with respect to the example upper boom 76. An example mounting plate 104 is a planar structure secured to the neck 108 opposite the spherical structure. The mounting plate 104 includes an aperture 107.

As shown in FIGS. 11-14, an image sensor 100 having a spring-operated clip is secured to the mounting plate 104 of the image sensor mount. The image sensor 100 operates with a cord 101. During use, the cord 101 can be secured within the upper boom channel 114 and the example lower boom channel 122. Alternatively, the stem 70 can include a cord-retention mechanism, for example a series of clips or ties. Alternatively still, an image sensor can operate wirelessly.

FIG. 15 shows the system 70 in a storage state. To change from an in-use state to a storage state, the stopper 90 is loosened from aperture 118 in the lower boom 74. The upper boom 76 is then completely inserted within the lower boom 74. The stopper 90 is then re-introduced to aperture 118. Through a friction fit, the secured stopper 90 prevents the upper boom 76 from exiting the lower boom 74. And, the bumpers 75 prevent the upper boom 76 from exiting the channel 122 of the lower boom 74. To remove the upper boom 76 from the lower boom 74, a user loosens the stopper 90 and slides the upper boom 76 from the upper end 116 of the lower boom 74. Also shown in storage state, the example foot (indicated by the support 128) is rotated upwardly so that the top surface of the adapter assembly 92 faces the interior of the channel 122 and the fastener 94 rests within the channel 122.

Alternatively, the lower boom 76 can be secured to the lower boom 74 by a hinge (not shown). This hinge (not shown) allows the lower boom 74 and the upper boom 76 to fold toward each other for storage and away from each other during use. During storage the booms 74, 76 rest in a parallel planar relationship (not shown). Additionally, during use, the booms 74, 76 can align in a longitudinal relationship.

The system 70 is secured to an base 78 with an fastener 94, as shown in FIGS. 10-16. The aperture 91 in the floor of the adapter assembly 92 aligns with an aperture 113 in the base 78. The fastener 94 secures the system 70 to the base 78 by inserting through the aperture 91 in the adapter assembly 92 and into the aperture 113 in the base 78. The fastener 94 and the aperture 113 in the base 78 can be correspondingly threaded. Alternatively, an example foot can swivel 360-degrees in a horizontal plane when secured to the example base 78. Alternatively still, an example base 78 can include more than one example aperture 113 so that at least one additional example stem 72 and foot 92 can be secured for simultaneous use.

The base 78 shown in FIGS. 10-15 includes a rigid plane so that it can rest in parallel with a flat surface. The base 78 can include a weighted material distributed within the base to counteract a forward-rotational momentum caused by the stem 72. The weighted material can be evenly distributed within the base 78.

The fastener 94 secures the adapter assembly 92 to the base 78 in order to counteract the forward-rotational momentum of the stem 72. Alternatively, the base 78 can include an internally extending slot to receive the planar foot of the adapter assembly 92. Preferably, the internally extending slot will begin along a rear edge of the base 78 and extend toward the front edge.

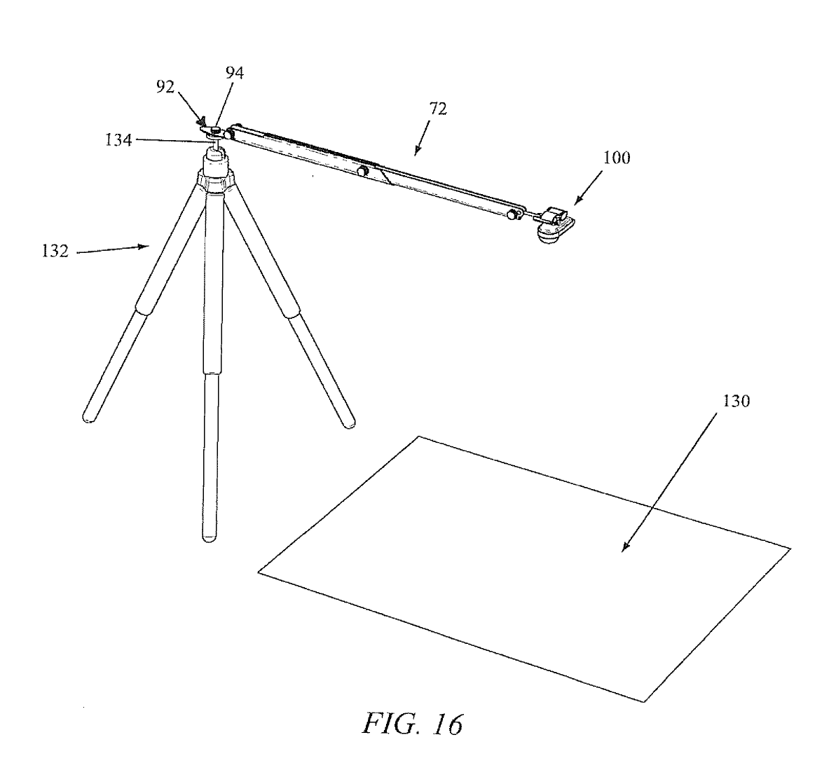

Alternatively, an example base can resemble a commonly-available tripod 132 shown in FIG. 16. The tripod 132 includes a mounting platform 134. The mounting platform 134 includes a threaded aperture or a threaded mounting stem (not shown). The adapter assembly 92 secures to the mounting platform 134 by attaching the fastener bolt 94 onto the threaded mounting stem (not shown) extending through the aperture 91 in the foot. An example stem in the mounting platform 134 can include threading that corresponds to threading on the example fastener 94. Alternatively a fastener can be secured through the aperture in the foot 92 and secured within an aperture on the mounting platform 134. As shown, the stem 72 extends outwardly from the tripod 132 so that the image sensor 100 views a document or object 130 from directly above.

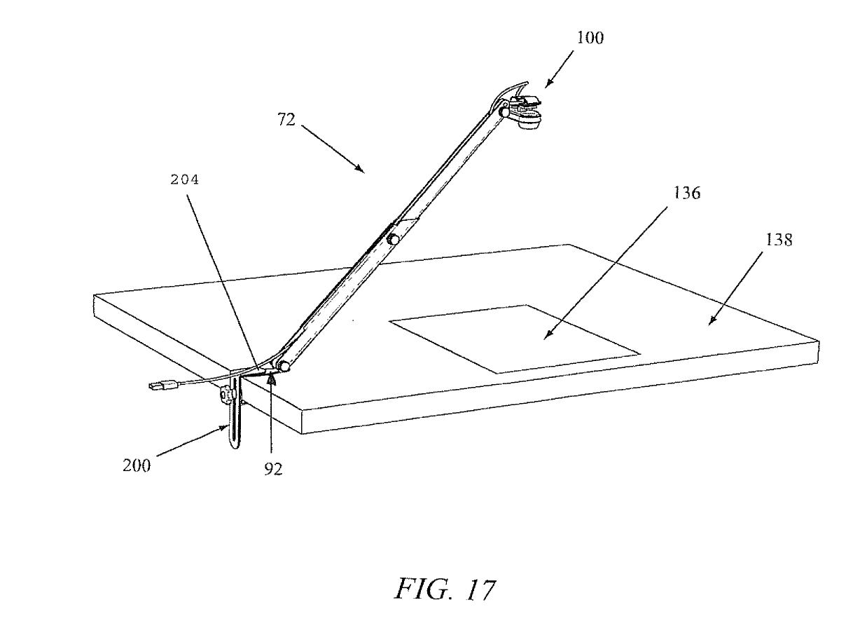

Alternatively still, as shown in FIG. 17, the adapter assembly 92 can be secured to the edge of a surface with a clamp 200 (or alternatively a “fastener”). An example clamp 200 includes a spine 202 and a fixed jaw 204 as shown in FIG. 15. The spine 202 can be a planar structure. The fixed jaw 216 is secured perpendicularly to the spine 202. The fixed jaw 204 is a planar structure with an outer face and an inner face. A pad 206 can be secured to the inner face of the fixed jaw 204. The pad 206 can be secured with adhesive. The spine 202 can include an elongated aperture 208 extending less than the entire length of the spine. A moveable jaw 210 is releasably secured to the spine 202 with a fastener 212. The moveable jaw 210 includes a mounting member 214 and a clamping member 216. The mounting member 214 includes an outer face and an inner face. The clamping member includes an outer face and an inner face.

The mounting member 214 includes an aperture. The fastener 212 can secure the mounting member 214 to the spine 202. The fastener can extend through the elongated aperture 208 in the spine 202 and through the aperture in the mounting member 214. The fastener 212 can be a screw that secures to a nut (not shown) through correspondingly threaded surfaces on the nut and the screw. Alternatively, the fastener 212 can be secured to the mounting member 214 with correspondingly-threaded surfaces on the fastener 212 and in the aperture in the mounting member 214. The clamping member 216 of the moveable jaw 216 can also include a pad (not shown, but similar to 206) secured to the inner face and situated opposite the fixed jaw pad 206.

As shown in FIG. 17, the adapter assembly 92 is secured to a horizontal surface 138 (or alternatively a “base”) with the clamp 200. The adapter assembly 92 is placed flat on the horizontal surface 138 and the fixed jaw 204 is placed over the planar section of the foot 92 (not shown). The moveable jaw 210 is then set such that the clamping member 216 is pushed to become flush with an opposing face of the horizontal surface 138. The fastener 212 then secures the movable jaw 210 in position on the spine 202. With the adapter assembly 92 secured to the horizontal surface 138 by the clamp 200, the image sensor 100 can be placed directly overhead of an example document or object 136.

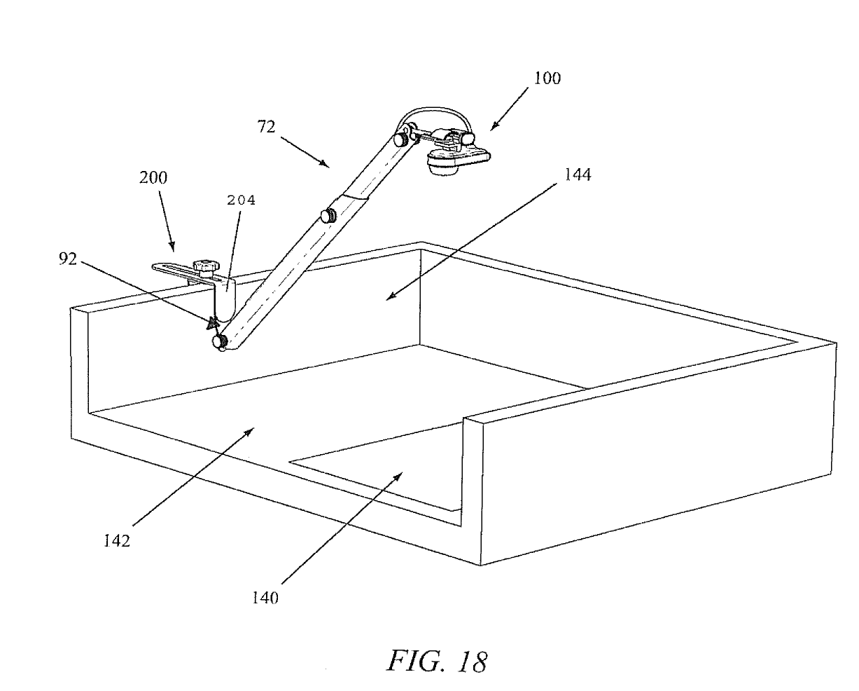

As shown in FIG. 18, the adapter assembly 92 can be secured to a vertical surface 144 (or alternatively a “base) with the clamp 200. The adapter assembly 92 is placed flat on the vertical surface 144 and the fixed jaw 204 is placed over the planar section of the foot 92 (not shown). The moveable jaw 210 is then set such that the clamping member 216 is pushed to become flush with an opposing face of the vertical surface 144. The fastener 212 then secures the movable jaw 210. With the foot 92 secured to the vertical surface 144 by the clamp 200, the image sensor 100 can be placed directly overhead of a document or object resting on a horizontal surface 142.

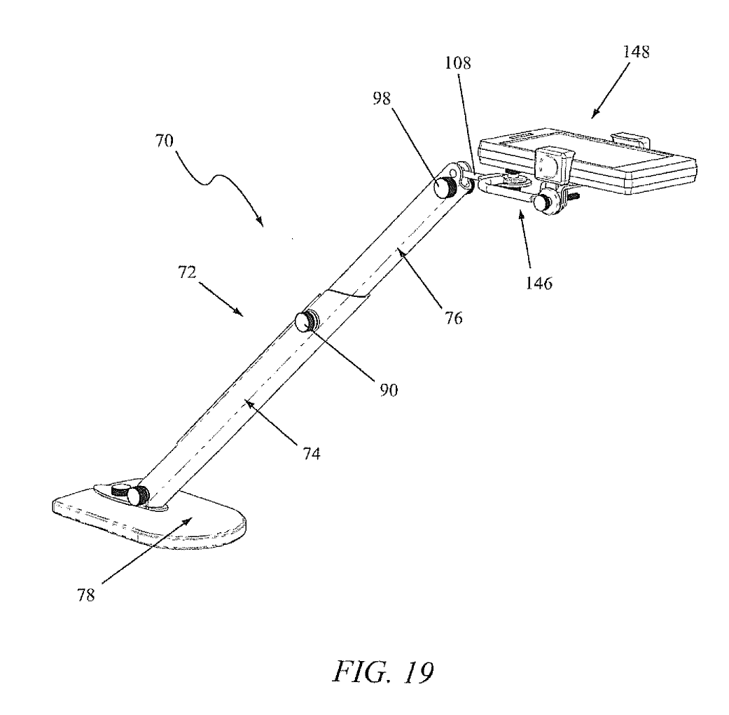

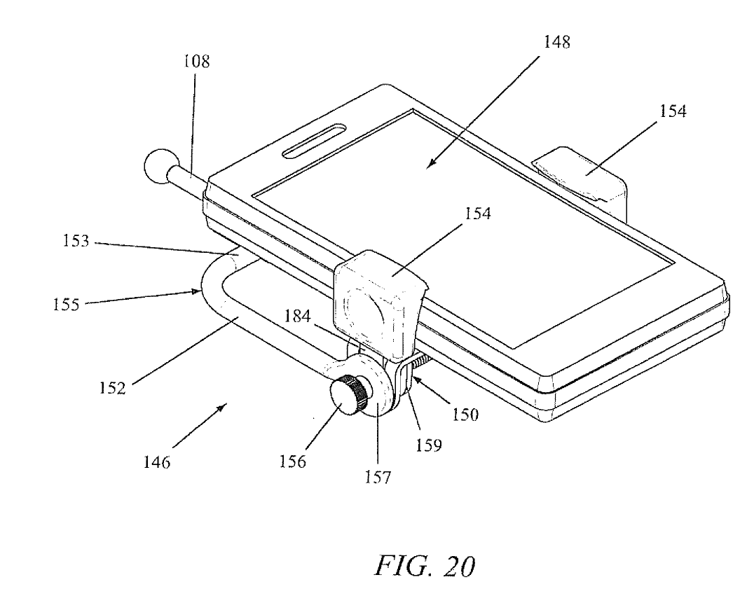

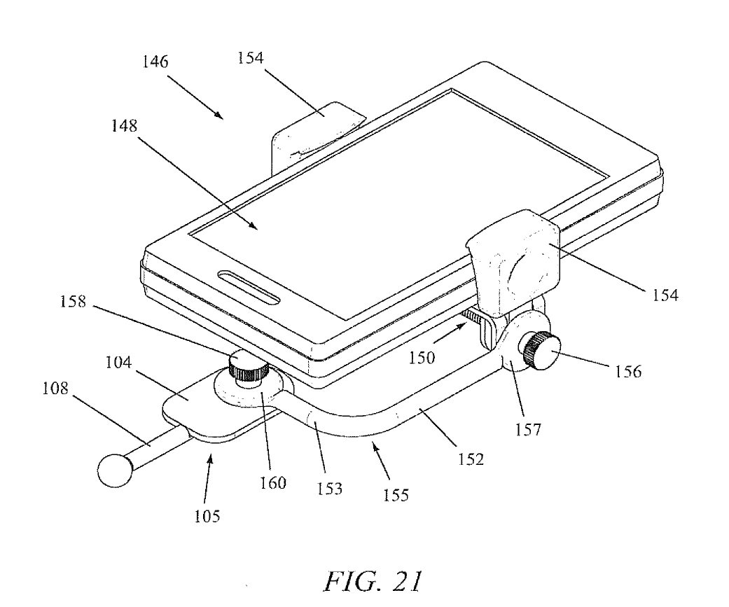

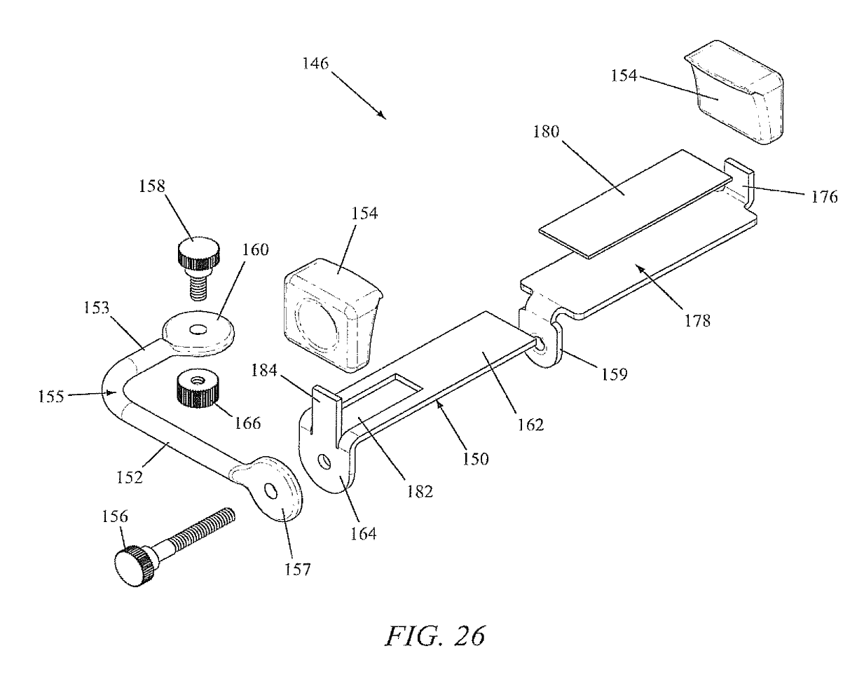

FIGS. 19-26 show an example cradle 146 for securing an image sensor 148 to the example image sensor mount 105. The image sensor 148 can be a mobile telephone. More preferably, the image sensor 148 can be a smart-phone, for example an APPLE IPHONE, or BLACKBERRY. The image sensor 148 can alternatively be a video imagery device such as a FlipVideo camera, a digital camera, or a combination device utilizing video or still photography. The cradle 146 can be secured to the mounting plate 104 of the image sensor mount 105 by inserting an example fastener 158 through an aperture in a first mounting member 160 and then through the aperture 107 in the mounting plate. The first mounting member 160 can be an annular ring including an aperture 181. An fastener 158 can be a threaded screw that is secured with a correspondingly-threaded nut 166 located on an opposite side of the first mounting member 160.

The first mounting member 160 can be secured to a rigid arm 155. The arm 155 can include a first member 153 secured perpendicularly with respect to a second member 152. The second mounting member 157 can be an annular ring with an aperture 179. The second mounting member 157 can be secured to the arm 155 at an end opposite of the first mounting member 160. As shown, the first mounting member 160 is arranged perpendicularly with respect to the second mounting member 157.

The cradle 146 can include a lower rib 150 that includes a horizontal planar member 162 positioned perpendicularly with respect to a vertical member 163. The vertical member 163 includes an upper finger 185 and a lower plane 164. The lower plane 164 includes an aperture 167 and can include a rounded edge. The horizontal planar member 162 can include an elongated aperture 182 extending from the vertical member 163. An example aperture 182 has a rectangular shape.

The cradle 146 can further include an upper rib 178 that includes a horizontal planar member 177 positioned perpendicularly with respect to a vertical member 159. The vertical member 159 can include a recessed section 169 and an aperture 173 positioned below the recessed section. The recessed section 169 of the upper rib 178 vertical member 159 is narrower than the aperture 182 in the lower rib 150. The curved section 159 has a diameter that is wider than the width of the aperture 182. The upper rib 178 further includes a vertical finger 176 positioned on a side of the upper rib 178 opposite from the vertical member 159.

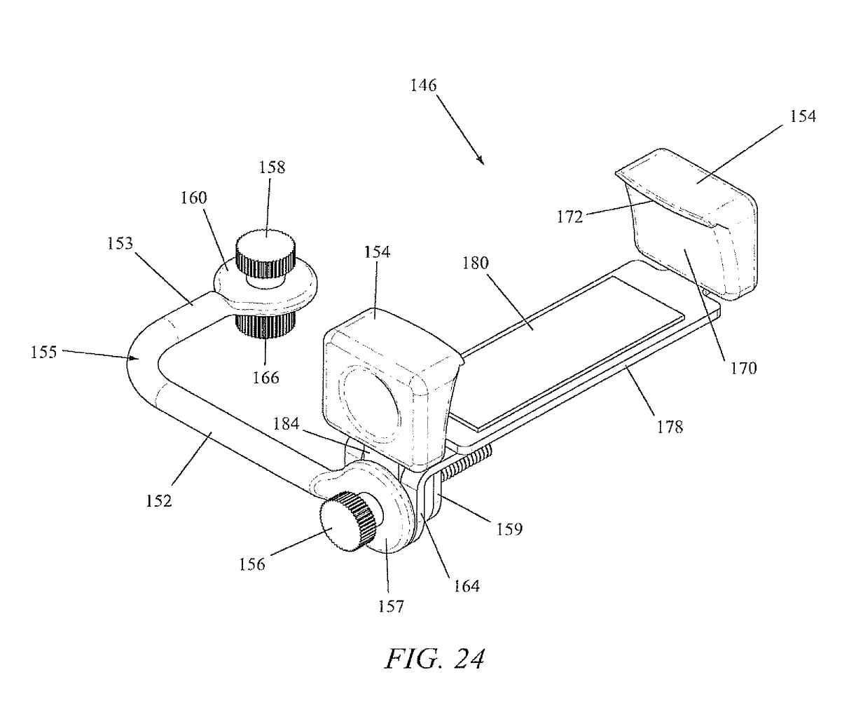

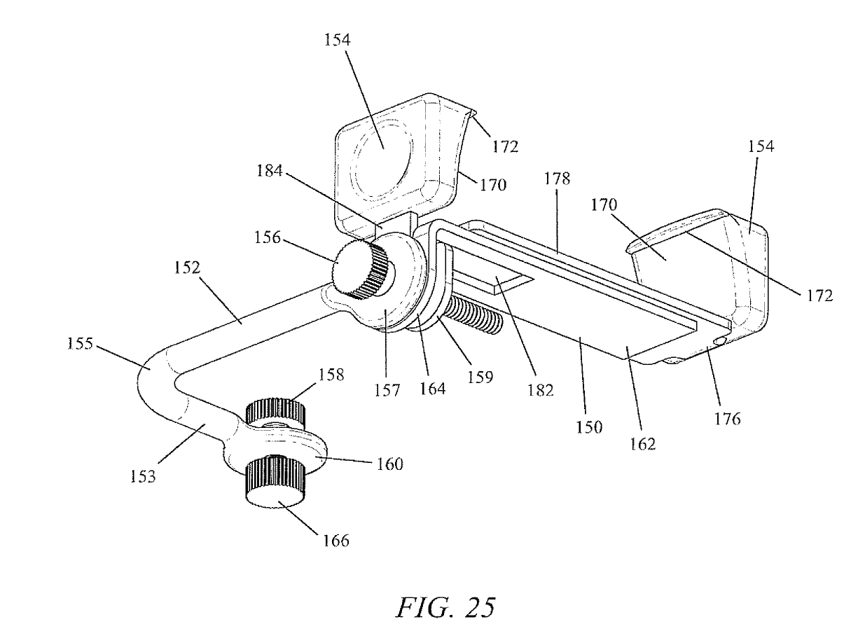

Assembled, as shown in FIGS. 24-25, the example upper rib 178 is positioned above the example lower rib 150. The vertical plane 159 is inserted downwardly through the elongated aperture 182 and the recessed section 169 fits within the aperture 182. Once the vertical member 159 is fully through the aperture 182, the upper rib 178 can be returned to align longitudinally with the lower rib 150. The aperture 167 on the vertical member 164 aligns with the aperture 173 in the vertical member 159. The aperture 179 in the cradle mounting member 157 aligns with the apertures 167, 173 in the vertical members 159, 164. A fastener 156 is secured within the aperture 179 of the ring 157, and the apertures 167, 173 of the two rib vertical members 159, 164.

As shown, the fastener 156 can include a threaded surface and can be a screw. The fastener 156 can be secured with a correspondingly threaded nut 183 on the opposite side of the vertical member 159. Alternatively, the fastener 156 can be secured within correspondingly threaded interior surfaces of the apertures 179, 167, 173 of the cradle mounting member 157 and/or vertical members 164, 159. As further shown, a plate 180 can be secured to the planar surface 162 of the upper rib 150 to increase stability. The plate 180 can be constructed of a lightweight material, for example plastic or aluminum. A further alternative plate 180 can be constructed of rubber.

In use, example friction grips 154 can be secured onto each vertical finger 176, 184 of the upper rib 150 and lower rib 178. Each friction grip 154 can include a slot (not shown) for receiving a vertical finger 176, 184. The slot can extend from the underside of each friction grip 154. Each friction grip 154 can include an interior face 170 and an upper lip 172. The upper lip 172 for each friction grip 154 faces inwardly toward the opposite friction grip 154. Each friction grip 154 can be constructed of a durable material, for example plastic or rubber.

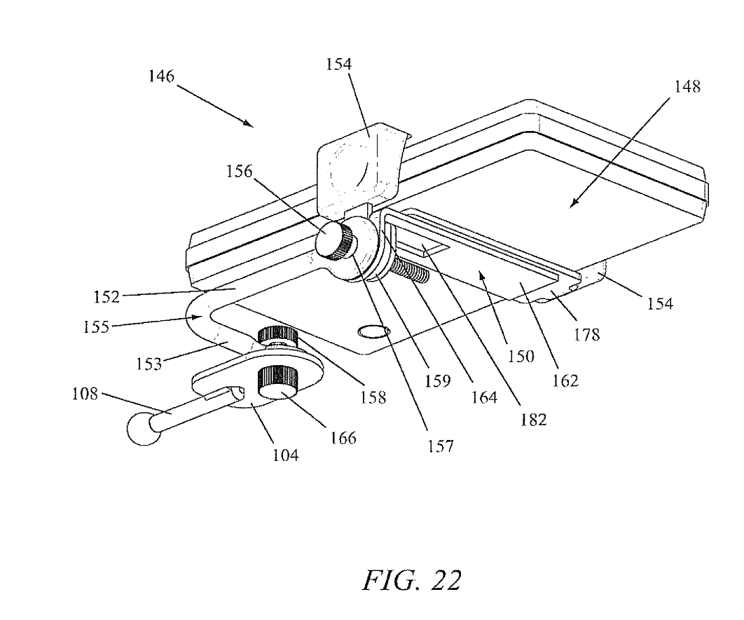

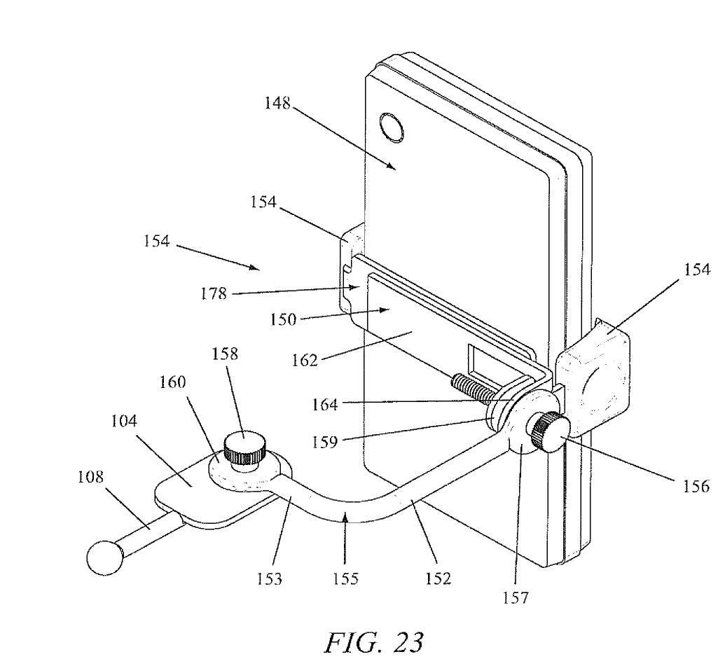

As shown in FIGS. 19-23, an image sensor 148 (e.g., smart phone) is secured to the cradle 146 by being inserted longitudinally between the friction grips 154 and resting atop the plate 180 secured on the upper rib 150. As shown, the state of the cradle 146 can be manipulated such that the image sensor 148 ribs 150, 178 are in planar correlation with the arm 155 (FIG. 22) or perpendicular to the arm (FIG. 23). Alternatively, the horizontal angle of the arm 155 with respect to the mounting plate 104 can be manipulated. Both vertical and horizontal manipulations of the position of the cradle 146 can be performed by sufficient force and/or by loosening the fasteners 156, 158 and re-tightening the same fastener once the cradle is repositioned. The cradle can be rapidly rotated 360 degrees both vertically and horizontally through the pivot points of the ball joint neck 108, the first mounting member pivot point 160, and the second mounting member pivot point 157.

Although this technology has been illustrated and described herein with reference to preferred embodiments and specific examples thereof, it will be readily apparent to those of ordinary skill in the art that other embodiments and examples can perform similar functions and/or achieve like results. All such equivalent embodiments and examples are within the spirit and scope of the technology described herein and are intended to be covered by the following claims.

While the invention has been described with reference to preferred and example embodiments, it will be understood by those skilled in the art that a variety of modifications, additions and deletions are within the scope of the invention, as defined by the following claims.

What is claimed is:

1. An image sensor support device comprising:
An adapter assembly releasably coupled with respect to a base; and
an image sensor mount rotatably coupled with respect to the adapter assembly.

2. The support device of claim 1, wherein the image sensor mount is rotatably secured to an elongated stem assembly and the stem assembly is rotatably secured to the adapter assembly.

3. The support device of claim 2, wherein the stem assembly rotates vertically with respect to the adapter assembly.

4. The support device of claim 2, wherein the adapter assembly comprises a foot and a pair of parallel vertical walls extending perpendicularly with respect to the foot.

5. The support device of claim 4, wherein the stem assembly is rotatably secured with a fastener releasably secured with respect to apertures located within each parallel vertical wall.

6. The support device of claim 4, wherein the foot is releasably secured to a base with a fastener.

7. The support device of claim 2, wherein a channel extends the entire length of the stem.

8. The support device of claim 2, wherein the stem assembly comprises a lower boom and at least one upper boom.

9. The support device of claim 8, wherein the stem assembly is capable of transitioning between a storage state and an in-use state.

10. The support device of claim 8, wherein a channel extends the entire length of the lower boom, and at least one upper boom is capable of being inserted within the lower boom channel.

11. The support device of claim 2, wherein the image sensor mount comprises an elongated neck secured to a mounting plate, wherein the elongated neck is rotatably coupled with respect to the stem assembly.

12. An image sensor support device comprising:
an elongated stem assembly rotatably coupled with respect to a body; and
an image sensor mount rotatably coupled with respect to the stem assembly.

13. The support device of claim 12, wherein the stem assembly comprises a lower boom and at least one upper boom.

14. The support device of claim 13, wherein a channel extends the entire length of the lower boom.

15. The support device of claim 14, wherein the at least one upper boom comprises dimensions sufficient to fit within the lower boom channel.

16. The support device of claim 14, wherein at least one bumper partially extends across the lower boom channel.

17. The support device of claim 12, further comprising an adapter assembly rotatably coupled with respect to the stem assembly, wherein the adapter assembly is releasably coupled with respect to the body.

18. An image sensor support device comprising:
a cradle rotatably coupled with respect to an arm;
a stem assembly rotatably coupled with respect to the arm, wherein the stem assembly is rotatably coupled with respect to a base.

19. The support device of claim 18, wherein the cradle comprises a pair of image sensor grips mounted to opposing sides of a rib system.

20. The support device of claim 18, wherein the base is an adapter assembly releasably coupled with respect to a body.
